(19) United States
(12) Patent Application Publication
(10) Pub. No.: US 2023/0113859 A1
(43) Pub. Date: Apr. 13, 2023

(54) POROUS MATERIAL WITH SURFACE-MODIFIED NANOARRAYS AND APPLICATION THEREOF

(71) Applicant: Tsinghua Shenzhen International Graduate School, Shenzhen (CN)

(72) Inventors: Qianyuan WU, Shenzhen (CN); Lu PENG, Shenzhen (CN); Haojie ZHU, Shenzhen (CN); Cheng YANG, Shenzhen (CN); Hongying HU, Shenzhen (CN)

(21) Appl. No.: 18/056,607

(22) Filed: Nov. 17, 2022

Related U.S. Application Data
(63) Continuation of application No. PCT/CN2022/095419, filed on May 27, 2022.

(30) Foreign Application Priority Data
Jun. 28, 2021 (CN) 2021107175331

(51) Int. Cl. C02F 1/44; B01D 69/14

(52) U.S. Cl. CPC C02F 1/442; B01D 69/14111; C02F 2201/005

(57) ABSTRACT

A porous material comprises a porous material substrate and nanostructure arrays that are in-situ grown on the porous material substrate; wherein a surface modification layer is arranged on the surface of the nanoarrays, and the surface modification layer is configured to increase the adhesion force between the nanoarrays and the microbes. The porous material is applied to disinfection, which comprises the steps: The porous material with the surface-modified nanoarrays is placed in flowing water, the water flow passes through the gaps of the nanoarrays in a shuttling mode, and in the shuttling flowing process, microbes come into contact with the nanoarrays. The microbes are torn up through the hydrodynamic force and the adhesion force between the nanoarrays and the microbes, so that the microbes are physically ruptured to achieve disinfection.

### CROSS REFERENCE TO RELATED APPLICATIONS

This application is a continuation application of PCT/CN2022/095419 filed on 2022-05-27, which claims priority to CN patent application NO. 202110717533.1 filed on 2021-06-28. The contents of the above-mentioned applications are all hereby incorporated by reference.

### TECHNICAL FIELD

The present invention relates to the field of microbial risk control, and in particular relates to a porous material with surface-modified nanoarrays and use thereof in disinfection.

### BACKGROUND ART

Traditional disinfection technologies (such as chlorination, ozonation, ultraviolet radiation, and high-temperature and high-pressure disinfection) are often associated with the formation of toxic byproducts, high energy consumption, and bacterial reactivation. In order to mitigate environmental risks and ensure water safety, development of safe and efficient disinfection technology is imperative. The mechano-bactericidal effect of nanomaterials is considered an ideal way to control microbial risks. During the contact between the nanostructures and the bacteria, the cell membrane can be deformed or punctured, leading to complete loss of cellular integrity and cell death. However, because of the small dimension and high curvature of the bacterial cell, the inward stress exerted by the nanostructures could be dispersed. And the bacteria can repair minor damages due to the fluidity of cell membrane. At present, the reported mechano-bactericidal actions usually require a long contact time (up to hours) or additional surface tension to achieve a more pronounced bactericidal effect. It should be noted that the information disclosed in the background section above is only for an understanding of the background of the present application and thus may include information that does not constitute prior art known to a person of ordinary skill in the art.

### SUMMARY OF THE INVENTION

The main object of the present invention is to overcome the shortcomings of the prior art, and propose a porous material with surface-modified nanoarrays to physically rupture the microbes through a different interaction mode between the nanostructures and the microbes. This invention helps to solve the problems of the existing mechano-bactericidal mechanism, such as a relatively low bactericidal efficiency and a long contact time.

For reaching the above-mentioned purpose, one aspect of the present invention proposes the following technical solutions:

A porous material with surface-modified nanoarrays, comprising: a porous material substrate, and nanostructure arrays that are in-situ grown on the porous material substrate; wherein a surface modification layer is arranged on the surface of the nanoarrays, and the surface modification layer is configured to increase the adhesion force between the nanostructures and the microbes.

Further, the nanostructure is elongated.

Further, the nanoarrays are nanospike arrays, nanowire arrays, or nanorod arrays.

Further, the nanostructure has an axial height of 5-10 µm and a radial dimension of 100-200 nm. Further, the surface modification layer is an adhesion layer that covers the surface of the nanoarrays and does not change the morphology of the nanostructure.

Further, the thickness of the adhesion layer is 5-15 nm.

Further, the adhesion layer is a carbon layer, gelatin, or poly-L-lysine.

Another aspect of the present invention is directed to the application of the porous material with surface-modified nanoarrays, comprising applying the porous material with surface-modified nanoarrays described above to sterilize and disinfect fluidic water; the sterilization and disinfection is achieved by physically rupturing the microbes during flow, and specifically, by tearing up the microbes through the hydrodynamic force and the adhesion force between the nanostructures and the microbes.

Further, the porous material with the surface-modified nanoarrays is placed in flowing water, so that the water flows through the gaps of the nanoarrays in a shuttling mode, and in the shuttling flowing process, the sterilization and disinfection is achieved.

The present invention achieves transient adhesion to the microorganisms such as bacteria by surface modification of nanoarrays. When the adhesion force acts on the bacteria, the hydrodynamic force generated by the fluid flow exerts an outward tension on the high-curvature surface of the bacteria to tear up the cells, causing irreversible physical rupture of the cell envelope, thus achieving sterilization and disinfection effect. Compared with traditional disinfection processes based on the mechano-bactericidal effect of nanomaterials, the present invention proposes the use of a porous material with surface-modified nanoarrays for sterilization and disinfection which has the following advantages:

1) The bacteria can be effectively inactivated by mild fluidic energy without the addition of chemical reagents. Compared with the antibacterial method that uses the pristine nanostructure arrays to rupture the cell wall, the inactivation efficiency of this method is improved by more than 5 log. 2) Short contact time: the modified nanoarrays of the present invention can cause irreversible physical damage to bacteria within a few seconds, leading to bacterial inactivation and no subsequent reactivation. 3) The bactericidal method of the present invention using the porous material with the surface-modified nanoarrays can be used for a broad spectrum of bacterial species, which effectively inactivates representative Gram-negative and Gram-positive bacteria in water. 4) The bactericidal method of the present invention using the porous material with the surface-modified nanoarrays is generally applicable. The bactericidal performance of nanoarrays can be significantly improved after surface modification, regardless of their chemical composition.

### BRIEF DESCRIPTION OF THE DRAWINGS

FIG. 1 shows schematic of utilizing a porous material with surface-modified nanoarrays for sterilization and disinfection according to an embodiment of the present invention;

FIG. 2 shows the inactivation performance of the surface-modified copper hydroxide nanowire arrays and the pristine copper hydroxide nanowire arrays against Escherichia coli;

FIGS. 3a-3d show the concentrations of four Gram-negative and Gram-positive bacteria during storage with and without disinfection treatment (The lines with circles represent bacteria after treatment, and the lines with triangles represent bacteria before treatment);

FIG. 4 shows the inactivation performance of the surface-modified zinc oxide nanorod arrays and the pristine zinc oxide nanorod arrays against Escherichia coli;

FIG. 5 shows the inactivation performance of the surface-modified Co, Mn-layered double hydroxides (LDH) nanowire arrays and the pristine Co, Mn-LDH nanowire arrays against Escherichia coli;

FIG. 6 shows the inactivation performance of the surface-modified titanate nanowire arrays and the pristine titanate nanowire arrays against Escherichia coli.

### DETAILED DESCRIPTION OF THE INVENTION

The present invention will be further described with reference to the accompanying drawings in conjunction with the detailed embodiments.

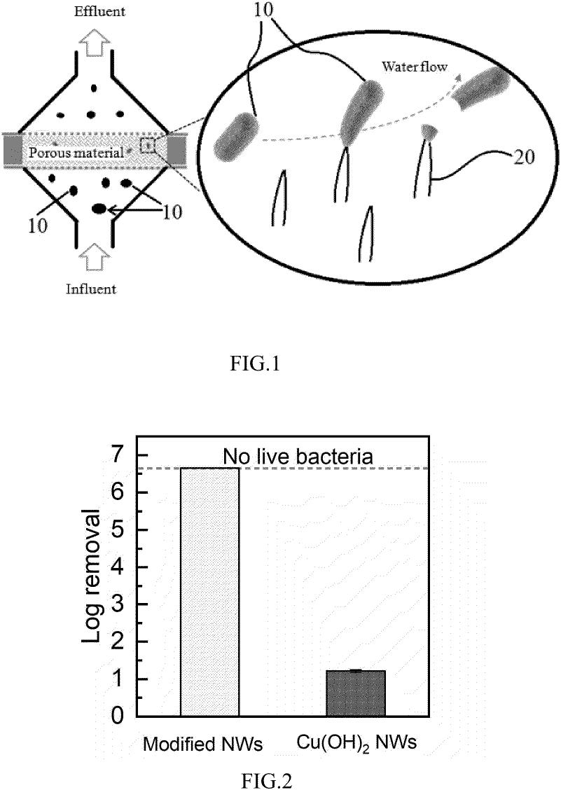

Embodiments of the present invention provide a method for efficient sterilization and disinfection using a porous material with surface-modified nanoarrays. The porous material with the surface-modified nanoarrays comprises a porous material substrate and nanostructure arrays that are in-situ grown on the porous material substrate. A surface modification layer is arranged on the surface of the nanoarrays, and the surface modification layer is configured to increase the adhesion force between the nanostructures and the microbes, e.g. bacteria. The porous material with the surface-modified nanoarrays is applied to disinfection, and the disinfection process is shown in FIG. 1, which comprises: the porous material with the surface-modified nanoarrays is placed in flowing water, so that the water flows through the gaps of the nanoarrays in a shuttling mode. In the shuttling flowing process, the nanostructures 20 come into contact with the flowing water, and the bacteria 10 are torn up through the hydrodynamic force (outward pull force) and the adhesion force between the nanostructures 20 and the bacteria 10, so that the bacteria are physically ruptured, achieving sterilization and disinfection.

The nanostructures constituting the nanoarrays are elongated, with an axial height of 5-10 µm and a radial dimension of 100-200 nm. In some embodiments, Dense nanospike arrays, nanowire arrays, or nanorod arrays can be in-situ grown on the porous material substrate. Preferably, embodiments of the present invention employ nanowire arrays for sterilization and disinfection. After the formation of the nanoarrays, a surface modification treatment is used to enhance the adhesion force between the nanostructures and the bacteria. Specifically, the surface of the nanoarrays is coated with an adhesion layer having a thickness of 5-15 nm so that the coating of the adhesion layer does not change the morphology of the nanostructure. The adhesion layer can be a carbon layer or be made of an adhesive material such as gelatin, poly-L-lysine, or the like.

In embodiments where the porous foam copper is used as the porous material substrate, a high density of copper hydroxide nanowire arrays is in-situ grown on the surface of the porous copper foam using a chemical oxidation process. A surface modification treatment is adopted to coat the copper hydroxide nanowire arrays with a layer of carbon to enhance the adhesion force between the nanoarrays and the bacterial membranes. In the disinfection process, a water sample containing bacteria is flowed vertically through the copper hydroxide nanowire arrays to be treated and the hydraulic residence time of the bacteria in contact with the nanowire arrays is controlled.

In addition, after surface modification with an adhesion layer, different types of nanoarrays can achieve efficient disinfection regardless of their chemical composition, including the zinc oxide nanorod arrays grown on a porous copper foam substrate, Co, Mn-LDH nanowire arrays grown on a porous nickel foam substrate, and titanate nanowire arrays grown on a porous titanium foam substrate, or other nanospike, nanorod, or nanowire arrays grown on a porous material substrate.

The effectiveness of the present invention is demonstrated by the following examples and comparative examples.

### Example 1

Surface-modified copper hydroxide nanowire arrays were prepared and placed in a closed pipeline as shown in FIG. 1. A water sample containing 10⁶-10⁷ CFU/mL of Escherichia coli (CGMCC 1.3373) was introduced into the pipeline by a water pump. Disinfection treatment was completed when the water sample flowed out of the nanowire arrays. The live bacterial concentrations in the influent and effluent water samples were determined by the plate counting method. The bacterial inactivation efficiency was evaluated by logarithmic inactivation rate, which is defined by -log₁₀ (N/N₀), where N₀ is the bacterial concentration in the influent and N is the bacterial concentration in the effluent. The inactivation rate of the surface-modified copper hydroxide nanowire arrays against Escherichia coli is shown in the bar graph (Modified NWs) in FIG. 2. The effluent bacteria were completely inactivated, and the inactivation rate reached more than 6 log.

### Comparative Example 1

The pristine unmodified copper hydroxide nanowire arrays were placed in a closed pipeline. A water sample containing 10⁶-10⁷ CFU/mL of Escherichia coli (CGMCC 1.3373) was introduced into the pipeline by a water pump. The water flow rate was the same as in Example 1 to ensure the same residence time of bacteria in contact with the nanowire arrays. Disinfection treatment was completed when the water sample flowed out of the nanowire arrays. The inactivation rate of the copper hydroxide nanowires against Escherichia coli in this comparative example is shown in the bar graph (Cu(OH)₂ NWs) in FIG. 2. The inactivation rate of the effluent bacteria was about 1 log.

### Example 2

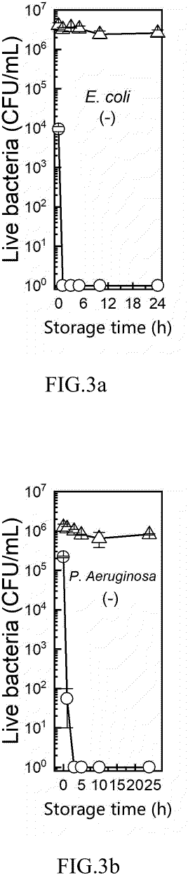

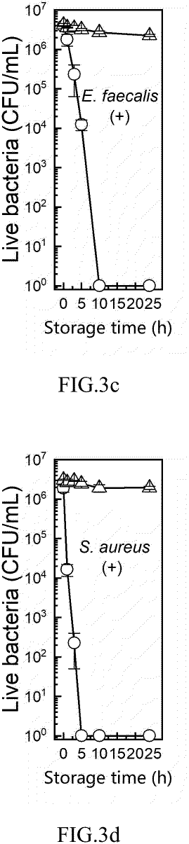

Four representative types of bacteria in water were treated by the surface-modified copper hydroxide nanowire arrays. The treated water samples were stored at 25° C. under visible light illumination. The live bacterial concentrations of each sample were measured at a series of storage times (0 h, 1 h, 5 h, 10 h, and 24 h) by the plate counting method. As shown in FIGS. 3A-3d, Gram-negative Escherichia coli (E. coli, CGMCC 1.3373), Pseudomonas aeruginosa (P. Aeruginosa, CGMCC 1.12483), and Gram-positive Enterococcus faecalis (E. faecalis, CGMCC 1.2135) and Staphylococcus aureus (S. aureus, CGMCC 1.12409) were all inactivated during storage, and the inactivation rates were all above 6 log without reactivation after the disinfection treatment of the present invention.

### Example 3

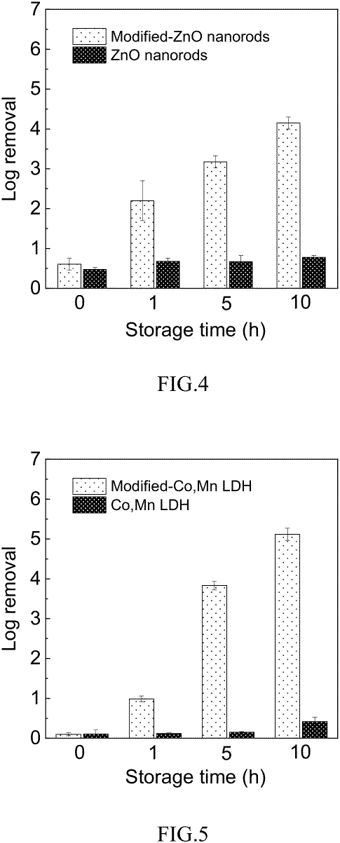

The zinc oxide nanorod arrays in-situ grown on the copper foam were prepared and treated by the same surface modification method. Escherichia coli was treated with the surface-modified and pristine unmodified zinc oxide nanorod arrays. Other operational steps were the same as in Example 1. The live bacterial concentrations in the treated effluent were measured at a series of storage times (0 h, 1 h, 5 h, and 10 h) by the plate counting method. The results are shown in FIG. 4. The surface-modified zinc oxide nanorod arrays (Modified-ZnO nanorods) achieved a 4-log inactivation rate of Escherichia coli, while the pristine zinc oxide nanorod arrays had no significant bactericidal effect.

### Example 4

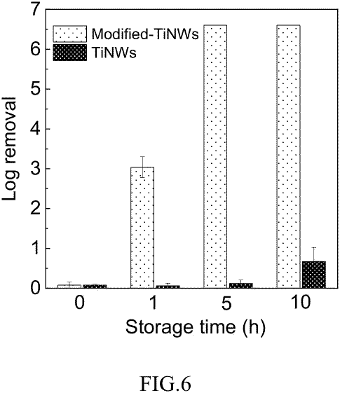

This example differed from Example 3 in that Co, Mn-LDH nanowire arrays in-situ grown on the nickel foam were used, and the other steps and parameters were the same as in Example 3. The results are shown in FIG. 5. The surface-modified Co, Mn-LDH nanowire arrays (Modified-Co, Mn LDH) achieved a 5-log inactivation rate of Escherichia coli, while the pristine Co, Mn-LDH nanowire arrays had no significant bactericidal effect.

### Example 5

This example differed from Example 3 in that titanate nanowire arrays in-situ grown on the titanium foam were used, and the other steps and parameters were the same as in Example 3. The results are shown in FIG. 6. The surface-modified titanate nanowire arrays (Modified-TiNWs) achieved a 6-log inactivation rate of Escherichia coli, while the pristine titanate nanowire arrays had no significant bactericidal effect.

To sum up, it is demonstrated that the use of the porous material with the surface-modified nanoarrays of the present invention is effective in water disinfection, and achieves high-efficiency inactivation of bacteria.

The background section of the present invention may contain background information about the problems or circumstances of the present invention, not necessarily describing the prior art. Therefore, what is contained in the background section is not an admission by the applicant of the prior art.

The foregoing is a further detailed description of the present invention in conjunction with specific/preferred embodiments thereof and is not to be construed as limiting the present invention to the specific embodiments described. For those skilled in the art to which the present invention pertains, without departing from the concept of the present invention, they can also make several alternatives or modifications to the described embodiments, and these alternatives or modifications should be regarded as belonging to the protection scope of the present invention. In the description of this specification, references to descriptions of the terms “one embodiment”, “some embodiments”, “preferred embodiment”, “example”, “specific examples”, or “some examples”, etc. mean that a particular feature, structure, material, or characteristic described in connection with the embodiment or example is included in at least one embodiment or example of the present invention. In this description, schematic representations of the terms above do not necessarily refer to the same embodiment or example. Furthermore, the particular features, structures, materials, or characteristics described may be combined in any suitable manner in any one or more embodiments or examples. The different embodiments or examples and the features of the different embodiments or examples described in this description can be integrated and combined by a person skilled in the art without contradicting each other. Although embodiments of the present invention and their advantages have been described in detail, it should be understood that various changes, substitutions, and alterations can be made herein without departing from the scope of the appended claims.

1. A porous material with surface-modified nanoarrays, comprising: a porous material substrate, and nanostructure arrays that are in-situ grown on the porous material substrate; wherein a surface modification layer is arranged on the surface of the nanoarrays, and the surface modification layer is configured to increase the adhesion force between the nanostructures and the microbes.

2. The porous material with the surface-modified nanoarrays of claim 1, wherein the nanostructure is elongated.

3. The porous material with the surface-modified nanoarrays of claim 1, wherein the nanoarrays are nanospike arrays, nanowire arrays, or nanorod arrays.

4. The porous material with the surface-modified nanoarrays of claim 1, wherein the nanostructure has an axial height of 5-10 µm and a radial dimension of 100-200 nm.

5. The porous material with the surface-modified nanoarrays of claim 1, wherein the surface modification layer is an adhesion layer that is coated on the surface of the nanoarrays and does not change the morphology of the nanostructure.

6. The porous material with the surface-modified nanoarrays of claim 5, wherein the adhesion layer has a thickness of 5-15 nm.

7. The porous material with the surface-modified nanoarrays of claim 5, wherein the adhesion layer is a carbon layer, gelatin, or poly-L-lysine.

8. Application of a porous material with surface-modified nanoarrays, comprising: the porous material with the surface-modified nanoarrays of claim 1 is applied to sterilization and disinfection; the sterilization and disinfection is achieved by physically rupturing the microbes during flow, and specifically by tearing up the microbes through the hydrodynamic force and the adhesion force between the nanostructures and the microbes.

9. Application of the porous material with the surface-modified nanoarrays of claim 8, wherein, the porous material with the surface-modified nanoarrays is placed in flowing water, the water flows through the gaps of the nanoarrays in a shuttling mode, and in the shuttling flowing process, the sterilization and disinfection is achieved.
